(19) United States
(12) Patent Application Publication
(10) Pub. No.: US 2019/0344743 A1
(43) Pub. Date: Nov. 14, 2019

(54) SEATBELT ASSEMBLY

(71) Applicant: Ford Global Technologies, LLC, Dearborn, MI (US)

(72) Inventors: Dean M. Jaradi, Macomb, MI (US); Mohammad Omar Faruque, Ann Arbor, MI (US); S.M. Iskander Farooq, Novi, MI (US); Zhenyan Gao, Northville, MI (US)

(73) Assignee: Ford Global Technologies, LLC, Dearborn, MI (US)

(21) Appl. No.: 15/978,757

(22) Filed: May 14, 2018

(51) Int. Cl. B60R 21/18; B60R 22/16; B60R 22/34; B60R 21/231

(52) U.S. Cl. CPC B60R 21/18; B60R 21/231; B60R 22/34; B60R 22/16

(57) ABSTRACT

A seatbelt assembly includes a retractor and an inflatable webbing. The inflatable webbing is supported by the retractor and elongated along an axis, the inflatable webbing having longitudinal threads extending along the axis and lateral threads interwoven with the longitudinal threads, the lateral threads extending transverse to the axis and being more stretchable than the longitudinal threads.

### BACKGROUND

A seatbelt system may include a seatbelt that extends across an occupant of a vehicle and controls kinematics of the occupant, e.g., during a vehicle collision. In this role, the seatbelt applies loads across the chest or lap of the occupant.

### BRIEF DESCRIPTION OF THE DRAWINGS

FIG. 1 is a perspective view of a vehicle having a seatbelt assembly with an inflatable webbing in an uninflated position.

FIG. 2 is a cross section of a middle portion of the inflatable webbing in the uninflated position.

FIG. 3 is a cross section of an opposing portion of the inflatable webbing in the uninflated position.

FIG. 4 is a perspective view of the vehicle having the seatbelt assembly with the inflatable webbing in an inflated position.

FIG. 5 is a cross section of the middle portion of the inflatable webbing in the inflated position.

FIG. 6 is a cross section of the opposing portion of the inflatable webbing in the inflated position.

FIG. 7 is a perspective view of the vehicle having the seatbelt assembly having another embodiment of the inflatable webbing in an uninflated position.

FIG. 8 is a cross section of a middle portion of the inflatable webbing of FIG. 7 in the uninflated position.

FIG. 9 is a cross section of the middle portion of the inflatable webbing of FIG. 7 in an inflated position.

FIG. 10 is a perspective view of the vehicle having the seatbelt assembly having another embodiment of the inflatable webbing in an uninflated position.

FIG. 11 is a cross section of a middle portion of the inflatable webbing of FIG. 10 in the uninflated position.

FIG. 12 is a cross section of the middle portion of the inflatable webbing of FIG. 10 in an inflated position.

FIG. 13 is a block diagram of an impact sensing system of the vehicle for inflating the inflatable webbing.

### DETAILED DESCRIPTION

A seatbelt assembly includes a retractor and an inflatable webbing. The inflatable webbing is supported by the retractor and elongated along an axis, the inflatable webbing having longitudinal threads extending along the axis and lateral threads interwoven with the longitudinal threads, the lateral threads extending transverse to the axis and being more stretchable than the longitudinal threads.

The inflatable webbing in an inflated position may have a necked portion.

The inflatable webbing in an inflated position may include a middle portion and opposing portions on opposite sides of the middle portion, the middle portion being smaller in cross-section perpendicular to the axis than the opposing portions.

The lateral threads may be at the opposing portions, and the inflatable webbing may include second lateral threads interwoven with the longitudinal threads at the middle portion, the second lateral threads extending transverse to the axis and being less stretchable than the lateral threads.

The longitudinal threads and the lateral threads may form a first panel and a second panel defining an inflation chamber.

The inflatable webbing may include a first edge and a second edge opposite the first edge, and the first panel may be fixed to the second panel at the middle portion between the first edge and the second edge and along the axis.

The inflation chamber at the middle portion may be spaced from the first edge and the second edge.

The inflation chamber at the middle portion may abut at least one of the first edge and the second edge.

The first panel may be releasably fixed to the second panel prior to inflation and released from the second panel in the inflated position.

The seatbelt assembly may include a latch plate and a D-ring, the opposing portions and the middle portion may be between the latch plate and the D-ring.

The inflatable webbing may include an inside surface and an impermeable coating along the inside surface.

The longitudinal threads may be nylon, and the lateral threads may be spandex.

A seatbelt assembly includes a retractor and an inflatable webbing. The inflatable webbing is elongated along an axis and supported by the retractor and inflatable to an inflated position, the inflatable webbing including a middle portion and opposing portions on opposite sides of the middle portion, the middle portion being smaller in cross-section perpendicular to the axis than the opposing portions when the inflatable webbing is in the inflated position.

The inflatable webbing may include longitudinal threads extending along the axis and lateral threads interwoven with the longitudinal threads at the opposing portions, the lateral threads extending transverse to the axis and being more stretchable than the longitudinal threads.

The inflatable webbing may include second lateral threads interwoven with the longitudinal threads at the middle portion, the second lateral threads extending transverse to the axis and being less stretchable than the lateral threads.

The inflatable webbing may include a first panel and a second panel each extending between a first edge and a second edge opposite the first edge, the first panel may be fixed to the second panel at the middle portion between the first edge and the second edge and along the axis.

The inflatable webbing may include an inflation chamber between the first panel and the second panel at the middle portion and spaced from the first edge and the second edge.

The inflatable webbing may include an inflation chamber between the first panel and the second panel at the middle portion and abutting at least one of the first edge and the second edge.

The inflatable webbing may include an inside surface and an impermeable coating along the inside surface.

The inflatable webbing may include a first panel and a second panel, the first panel releasably fixed to the second panel prior to inflation of the inflatable webbing and released from the second panel in the inflated position.

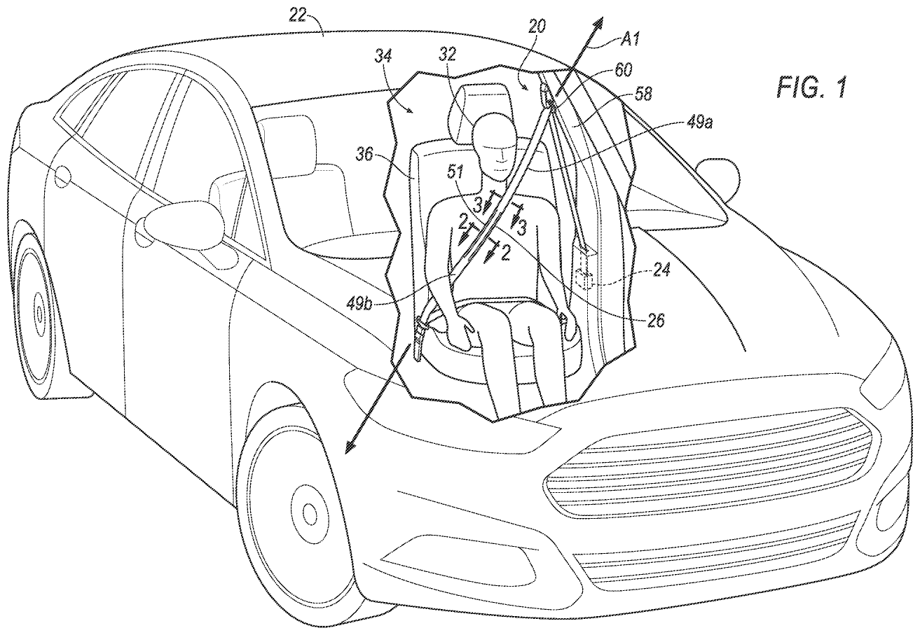

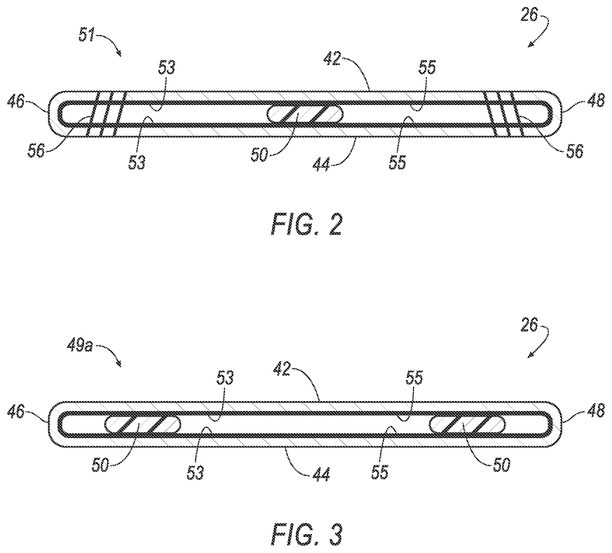

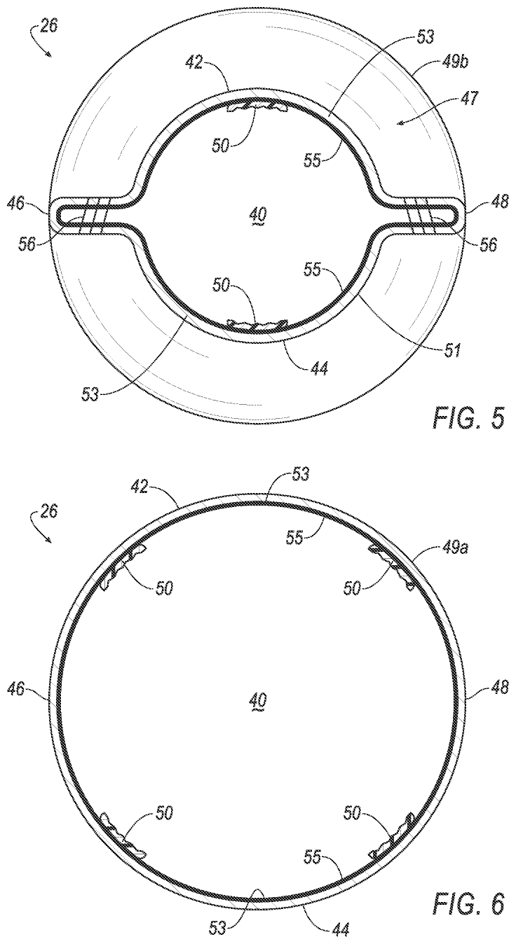

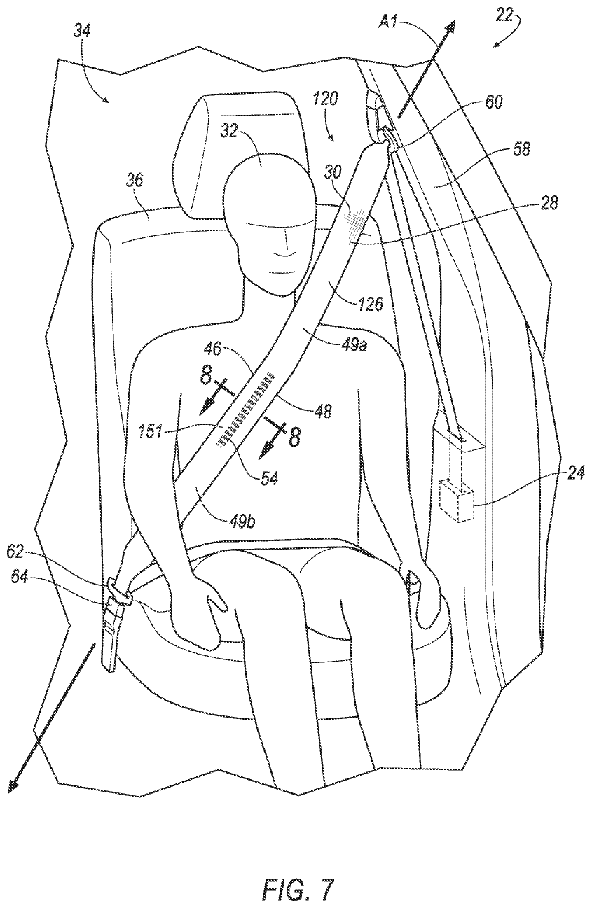

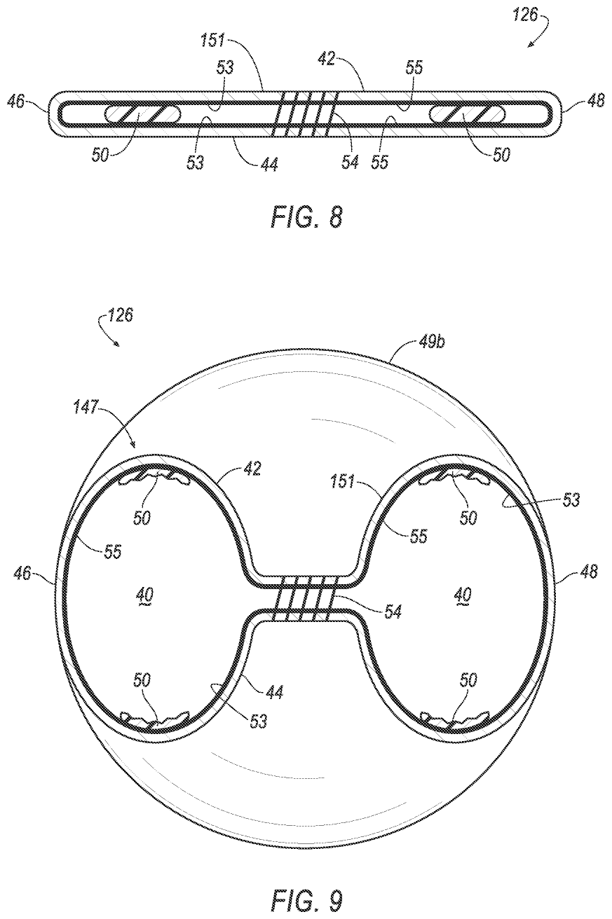

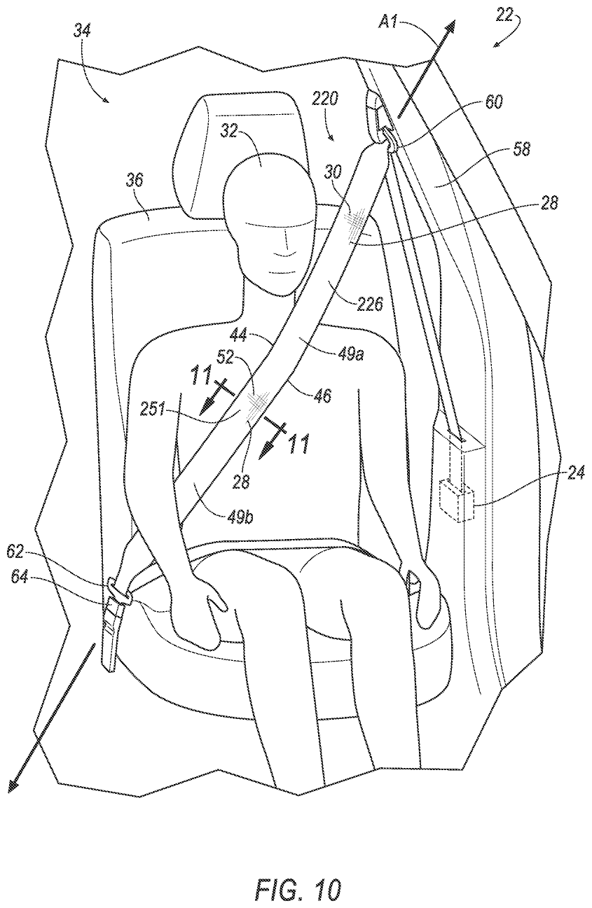

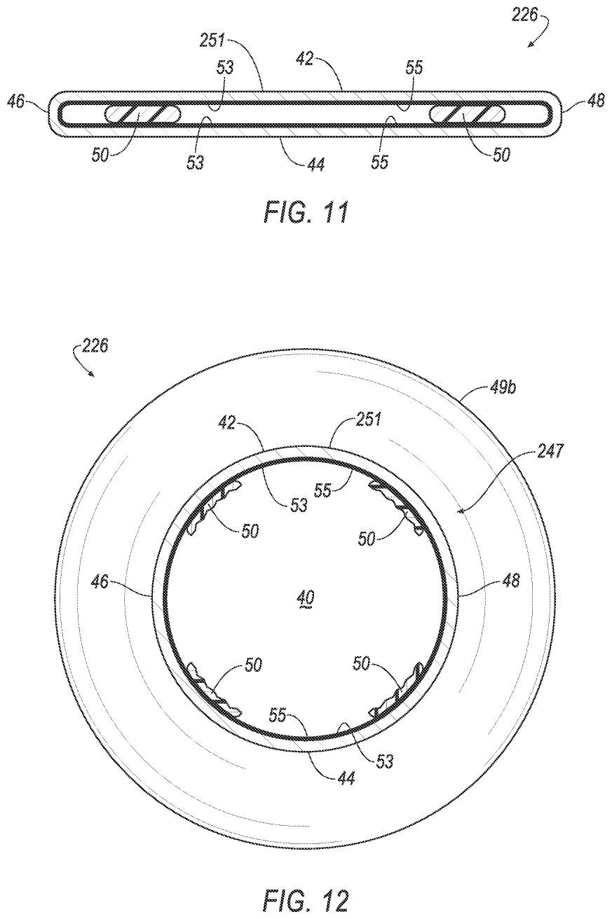

With reference to the Figures, wherein like numerals indicate like parts throughout the several views, a seatbelt assembly 20, 120, 220 for a vehicle 22 includes a retractor 24 and an inflatable webbing 26, 126, 226 supported by the retractor 24. The inflatable webbing 26, 126, 226 is elongated along an axis A1. The inflatable webbing 26, 126, 226 has longitudinal threads 28 extending along the axis A1 and first lateral threads 30 interwoven with the longitudinal threads 28. The first lateral threads 30 extend transverse to the axis A1 and are more stretchable than the longitudinal threads 28. The inflatable webbing may also include a middle portion 51, 151, 251 and opposing portions 49a, 49b (also referred to herein as first portion 49a and second portion 49b). The middle portion 51, 151, 251 inflates to a smaller size than the first portion 49a and the second portion 49b. One embodiment of the seatbelt assembly 20 is shown in FIGS. 1-6, another embodiment of the seatbelt assembly 120 is shown in FIGS. 7-9, and yet another embodiment of the seatbelt assembly 220 is shown in FIGS. 10-12. Common numerals are used to identify common features throughout the Figures.

The relative stretchability between the first lateral threads 30 and the longitudinal threads 28 enables the inflatable webbing 26, 126, 226 to expand radially, e.g., as the first lateral threads 30 stretch, and not axially, e.g., as the longitudinal threads 28 refrain from stretching and maintain a constant length, when the inflatable webbing 26, 126, 226 is inflated. Such expansion, and lack thereof, enables the inflatable webbing 26, 126, 226 to distribute force generated on, and to control kinematics of, an occupant 32 of the vehicle 22 during a vehicle impact. The relative size of the middle portion 51, 151, 251, and the first portion 49a and the second portion 49b also aid in distributing such force, e.g., with more force applied to the occupant 32 by the first portion 49a and the second portion 49b than by the middle portion 51, 151, 251.

The vehicle 22 may be any passenger or commercial automobile such as a car, a truck, a sport utility vehicle, a crossover vehicle, a van, a minivan, a taxi, a bus, etc.

The vehicle 22 includes a passenger cabin 34 to house occupants 32, if any, of the vehicle 22. The passenger cabin 34 includes one or more seats 36 disposed in the passenger cabin 34. The seats 36 are shown to be bucket seats, but the seats 36 may be other types. The position and orientation of the seats 36 and components thereof may be adjustable by the occupant 32.

The seatbelt assembly 20, 120, 220 controls kinematics of the occupant 32 of one of the seats 36. In other words, the seatbelt assembly 20, 120, 220 controls movement of the occupant 32 relative to the seat 36.

The inflatable webbing 26, 126, 226 is elongated along the axis A1. In other words, the inflatable webbing 26, 126, 226 may extend along the axis A1 in a length direction of the inflatable webbing 26, 126, 226, e.g., when the inflatable webbing 26, 126, 226 is paid out from the retractor 24.

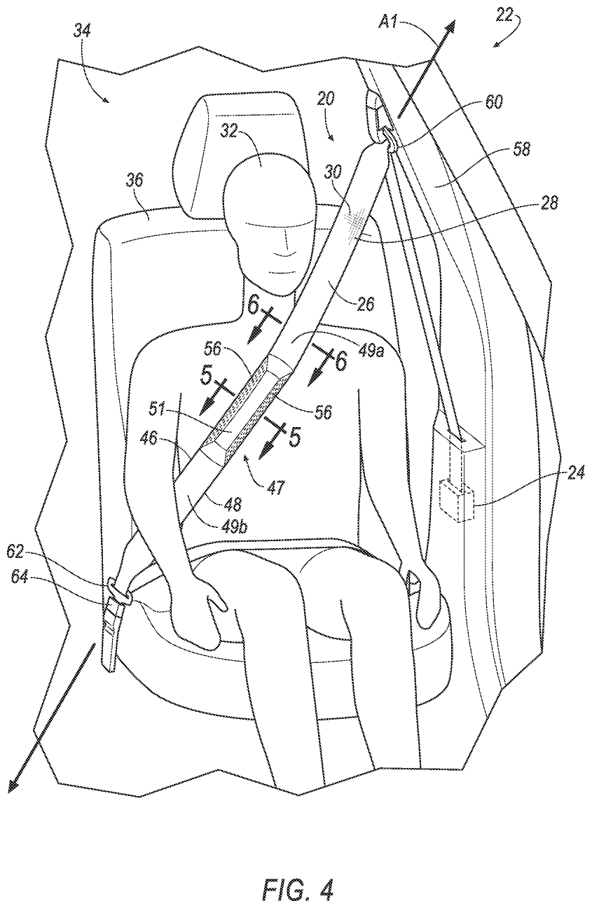

The inflatable webbing 26, 126, 226 is inflatable, e.g., to reduce force applied to the occupant 32 during a vehicle impact. For example, the inflatable webbing 26, 126, 226 may move from an uninflated position, shown in FIGS. 1-3, 7, 8, 10, and 11, to an inflated position, shown in FIGS. 4-6, 9, and 12, e.g., in response to receiving inflation medium from an inflator 38. The inflatable webbing 26, 126, 226 may define an inflation chamber 40. The inflation chamber 40 may be continuous through the first portion 49a, the second portion 49b, and the middle portion 51, 151, 251.

The inflatable webbing 26, 126, 226 may include a first panel 42 and a second panel 44. The first panel 42 and the second panel 44 enable the inflatable webbing 26, 126, 226 to be inflatable. For example, the inflation chamber 40 may be between the first panel 42 and the second panel 44. The inflatable webbing 26, 126, 226 may include a first edge 46 and a second edge 48. The first edge 46 and the second edge 48 may be elongated along the axis A1. The first edge 46 may be spaced from the second edge 48 with the inflatable webbing 26, 126, 226 therebetween. In other words, the first edge 46 may be opposite the second edge 48. The first panel 42 and the second panel 44 may each extend between the first edge 46 and the second edge 48. The first panel 42 and the second panel 44 may be elongated along the axis A1. The first panel 42 may meet the second panel 44 at the first edge 46 and the second edge 48 along the axis A1. The first panel 42 may be fixed to the second panel 44 along the first edge 46 and the second edge 48, e.g., via stitching, etc. The first panel 42 and the second panel 44 may be monolithic, i.e., a single, uniform piece of material with no seams, joints, fasteners, or adhesives holding the first panel 42 and the second panel 44 together, e.g., one-piece woven.

The first panel 42 may be releasably fixed to the second panel 44 prior to inflation of the inflatable webbing 26, 126, 226. The first panel 42 may be released from the second panel 44 when the inflatable webbing 26, 126, 226 is inflated to the inflated position. The releasable fixation helps to maintain a flat shape to the inflatable webbing 26, 126, 226 in the uninflated position and enables the inflatable webbing 26, 126, 226 to inflate to the inflated position. For example, adhesive 50 may bond the first panel 42 to the second panel 44 prior to inflation of the inflatable webbing 26, 126, 226. Upon receiving inflation medium from the inflator 38, the bond from the adhesive 50 between the first panel 42 and the second panel 44 may break as the inflatable webbing 26, 126, 226 moves from the uninflated position to the inflated position and permitting the first panel 42 to move away from the second panel 44 at the adhesive 50.

The inflatable webbing 26, 126, 226 may include an inside surface 53. The inside surface 53 may be hidden from the occupant 32. For example, the inside surface 53 may be surfaces of the first panel 42 and the second panel 44 that face each other. The inflatable webbing 26, 126, 226 may include an impermeable coating 55 along the inside surface 53, e.g., to restrict fluid flow out of the inflation chamber 40 through the first panel 42 and/or the second panel 44 in the inflated position. The impermeable coating 55 may be rubber or any other suitable material.

The inflatable webbing 26, 126, 226 in the inflated position may have a necked portion 47, 147, 247. The necked portion 47, 147, 247 of the inflatable webbing 26, 126, 226 in the inflated position is narrower than portions of the inflatable webbing 26, 126, 226 in the inflated position on opposite sides of the necked portion 47, 147, 247. The necked portion 47, 147, 247 may apply lower pressure to the occupant 32 restrained by the seatbelt assembly 20, 120, 220 than portions of the inflatable webbing 26, 126, 226 on opposite sides of the necked portion 47, 147, 247.

The inflatable webbing 26, 126, 226 in the inflated position may include the first portion 49a, the second portion 49b, and the middle portion 51, 151, 251. The middle portion 51, 151, 251, the first portion 49a, and the second portion 49b may provide the necked portion 47, 147, 247. The middle portion 51, 151, 251 is between the first portion 49a and the second portion 49b. In other words, the first portion 49a and the second portion 49b on opposite side of the middle portion 51, 151, 251. The middle portion 51, 151, 251 is smaller in cross-section perpendicular to the axis A1 than the first portion 49a and the second portion 49b. For example, an area of the inflation chamber 40 in cross-section perpendicular to the axis A1 at the middle portion 51, 151, 251 may be less than an area of the inflation chamber 40 in cross-section perpendicular to the axis A1 at the first portion 49a and the second portion 49b. As another example, a diameter of the inflation chamber 40 at the middle portion 51, 151, 251 may be less than a diameter of the inflation chamber 40 at the first portion 49a and the second portion 49b. As another example, a distance between the first panel 42 and the second panel 44 at the middle portion 51, 151, 251 may be less than a distance between the first panel 42 and the second panel 44 at the first portion 49a and the second portion 49b.

With reference to the seatbelt assembly 20, 120 shown in FIGS. 1-9, the first panel 42 may be fixed to the second panel 44 at the middle portion 51, 151 between the first edge 46 and the second edge 48 and along the axis A1, e.g., with stitching 54, 56, etc. Fixing the first panel 42 to the second panel 44 at the middle portion 51, 151 provides the necked portion 47, 147 in the inflated position. For example, the stitching 54, 56 may providing the smaller cross-sectional area of the middle portion 51, 151 relative to the first portion 49a and the second portion 49b.

With reference to the seatbelt assembly 20 shown in FIGS. 1-6, the first panel 42 may be fixed, e.g., with stitching 56, to the second panel 44 along the axis A1 and adjacent the first edge 46 and the second edge 48, e.g., with the inflation chamber 40 spaced from the first edge 46 and the second edge 48 at the middle portion 51. In other words, the inflation chamber 40 may be between the stitching 56 adjacent the first edge 46 and the stitching 56 adjacent the second edge 48.

With reference to the seatbelt assembly 120 shown in FIGS. 7-9, the first panel 42 may be fixed, e.g., with stitching 54, to the second panel 44 along the axis A1 midway between the first edge 46 and the second edge 48, e.g., with the inflation chamber 40 abutting at least one of the first edge 46 and the second edge 48 at the middle portion 151. In other words, the inflation chamber 40 may be between the stitching 54 and the first edge 46 and/or the inflation chamber 40 may be between the stitching 54 and the second edge 48.

Returning to FIGS. 1-12, the inflatable webbing 26, 126, 226 has longitudinal threads 28. The longitudinal threads 28 extend along the axis A1. For example, the longitudinal threads 28 may be warp threads. The longitudinal threads 28 may be nylon, or any suitable material. Although only shown on a portion of the inflatable webbing 26, 126, 226, it is to be understood that the longitudinal threads 28 may extend along the entire length of the inflatable webbing 26, 126, 226. It is to be further understood that the longitudinal threads 28 may be arranged next to each other between the first edge 46 and the second edge 48, and that the longitudinal threads 28 are not shown to scale. To put it another way, the longitudinal threads 28 may be thinner and closer together than shown, e.g., the longitudinal threads 28 may have a higher thread count than shown.

The inflatable webbing 26, 126, 226 has first lateral threads 30. The first lateral threads 30 extend transverse to the axis A1. For example, the first lateral threads 30 may be weft threads. The first lateral threads 30 may be spandex, or any suitable material. Although only shown on a portion of the inflatable webbing 26, 126, 226, it is to be understood that the first lateral threads 30 may extend along the entire width of the inflatable webbing 26, 126, 226, e.g., from the first edge 46 to the second edge 48, and that the first lateral threads 30 are not shown to scale. To put it another way, the first lateral threads 30 may be thinner and closer together than shown, e.g., the first lateral threads 30 may have a higher thread count than shown. The first lateral threads 30 are interwoven with the longitudinal threads 28, e.g., to form the first panel 42 and/or the second panel 44.

The first lateral threads 30 are more stretchable than the longitudinal threads 28. In other words, an amount of force required to stretch the first lateral threads 30 a certain distance is less than an amount of force required to stretch the longitudinal threads 28 such distance. For example, a Young's modulus of the first lateral threads 30 may be less than a Young's modulus of the longitudinal threads 28. As another example, the spandex of the first lateral threads 30 may be more stretchable than the nylon of the longitudinal threads 28. The first lateral threads 30 may be at the first portion 49a, the second portion 49b, and the middle portion 51, 151.

The relative stretchability between the first lateral threads 30 and the longitudinal threads 28 enables the inflatable webbing 26, 126, 226 to expand radially, e.g., as the first lateral threads 30 stretch, and not axially, e.g., as the longitudinal threads 28 refrain from stretching, when the inflatable webbing 26, 126, 226 moves from the uninflated position to the inflated position. In other words, the first lateral threads 30 stretch to provide inflation and expansion of the first portion 49a and the second portion 49b, and the longitudinal threads 28 do not stretch to maintain a length of the inflatable webbing 26, 126, 226 to restrain the occupant 32.

With reference to the seatbelt assembly 220 shown in FIGS. 10-12, the inflatable webbing 226 may include second lateral threads 52. The second lateral threads 52 may extend transverse to the axis A1. The second lateral threads 52 may be interwoven with the longitudinal threads 28. The second lateral threads 52 may be at the middle portion 251. For example, the second lateral threads 52 may be weft threads. The second lateral threads 52 may be nylon, or any suitable material. Although only shown on a portion of the inflatable webbing 226 it is to be understood that the second lateral threads 52 may extend along the entire width of the inflatable webbing 226, e.g., from the first edge 46 to the second edge 48, and that the second lateral threads 52 are not shown to scale. To put it another way, the second lateral threads 52 may be thinner and closer together than shown, e.g., the second lateral threads 52 may have a higher thread count than shown. The longitudinal threads 28, the first lateral threads 30, and/or the second lateral threads 52 may form the first panel 42 and/or the second panel 44. Although not shown, it is to be understood that the inflatable webbing 26, 126 of FIGS. 1-9 may include the second lateral threads 52, e.g., at the middle portion 51, 151.

With continued reference to the seatbelt assembly 220 shown in FIGS. 10-12, the second lateral threads 52 may be less stretchable than the first lateral threads 30. In other words, an amount of force required to stretch the second lateral threads 52 a certain distance is greater than an amount of force required to stretch the first lateral threads 30 such distance. For example, a Young's modulus of the second lateral threads 52 maybe greater than the Young's modulus of the first lateral threads 30. As another example, the spandex of the first lateral threads 30 may be more stretchable than the nylon of the second lateral threads 52.

With continued reference to the seatbelt assembly 220 shown in FIGS. 10-12, the relative stretchability between the first lateral threads 30 and the second lateral threads 52 enables the first portion 49a and the second portion 49b to radially expand more than the middle portion 251 when the inflatable webbing 226 is inflated, e.g., to provide the necked portion 247.

Returning to the embodiments shown in FIGS. 1-12, the retractor 24 may be attached to a component of the vehicle 22, e.g., to a pillar 58, to one of the seats 36, etc. The retractor 24 may be attached in any suitable manner, e.g., with one or more fasteners, etc. The retractor 24 may include a spool. The spool may freely rotate within the retractor 24. The spool may be adapted to receive the inflatable webbing 26, 126, 226, for example, by including a webbing attachment slot and permitting the inflatable webbing 26, 126, 226 to wind around the spool. The retractor 24 may include a locking mechanism that inhibits rotation of the spool when the vehicle 22 is subject to deceleration above a threshold amount, e.g., during a vehicle impact. The inflatable webbing 26, 126, 226 may be supported by the retractor 24. For example, the inflatable webbing 26, 126, 226 may be attached to the spool, with the inflatable webbing 26, 126, 226 wound around the spool. The inflatable webbing 26, 126, 226 may be payable from the retractor 24, e.g., when the spool is not prevented from rotating by the locking mechanism.

The seatbelt assembly 20, 120, 220 may include a D-ring 60. The D-ring 60 supports the inflatable webbing 26, 126, 226 and redirects tension applied thereto. The D-ring 60 may include a slot. The inflatable webbing 26, 126, 226 may be slidably disposed within the slot. The D-ring 60 may be attached to a component of the vehicle 22, e.g., to the pillar 58, to one of the seats 36, etc. The D-ring 60 may be metal, plastic, or any suitable material.

The seatbelt assembly 20, 120, 220 may include a latch plate 62. The latch plate 62 can be rectangular or any other suitable shape. The latch plate 62 can include a hole, a notch, etc., to receive a latch of a buckle 64. The latch plate 62 may be supported by the inflatable webbing 26, 126, 226. For example, the latch plate 62 may be fixed to the inflatable webbing 26, 126, 226, e.g., with a fastener, etc. As another example, the latch plate 62 may include a slot, and the inflatable webbing 26, 126, 226 may be friction fit within the slot.

The buckle 64 engages with the latch plate 62 to secure the seatbelt assembly 20, 120, 220 and restrain the occupant 32 relative to the seat 36. The buckle 64 may include the latch, or any other suitable structure, to engage the latch plate 62. The buckle 64 may be supported by the seat 36, or any other suitable vehicle structure.

The first portion 49a, the second portion 49b, and the middle portion 51, 151, 251 of the inflatable webbing 26, 126, 226 may be between the latch plate 62 and the D-ring 60. For example, the inflatable webbing 26, 126, 226 may extend between the latch plate 62 and the D-ring 60 across the seat 36 when the latch plate 62 is engaged with the buckle 64, e.g., with the first portion 49a, the second portion 49b, and the middle portion 51, 151, 251 extending across the occupant 32 of the seat 36.

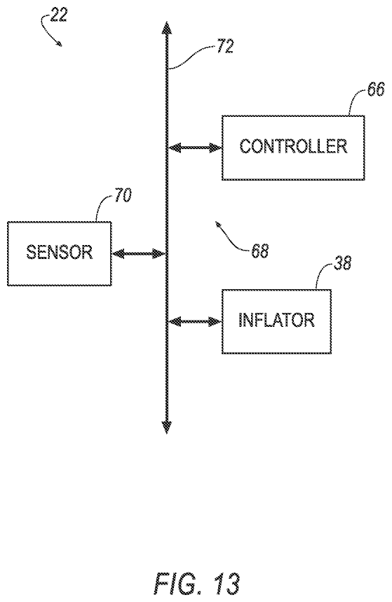

The inflator 38, shown in FIG. 13, may be connected to the inflatable webbing 26, 126, 226. For example, the inflator 38 may be in fluid communication with the inflation chamber 40 directly, via a fill tube, etc. Upon receiving a signal from, e.g., a vehicle controller 66, the inflator 38 may inflate the inflatable webbing 26, 126, 226 with inflatable medium, such as a gas. The inflator 38 may be, for example, a pyrotechnic inflator that uses a chemical reaction to drive inflation medium to the inflatable webbing 26, 126, 226. The inflator 38 may be of any suitable type, for example, a cold-gas inflator. The inflator 38 may be supported by the pillar 58, the buckle 64, the latch plate 62, the retractor 24, or at any suitable location.

With continued reference to FIG. 13, the vehicle 22 may include an impact sensing system 68. The impact sensing system 68 may include at least one sensor 70 for sensing an impact of the vehicle 22, the controller 66 in communication with the sensor 70, and the inflator 38. Alternatively or additionally to sensing impact, the impact sensing system 68 may be configured to sense impact prior to impact, i.e., pre-impact sensing. The sensor 70 may be of any suitable type, e.g., using radar, lidar, and/or a vision system. The vision system may include one or more cameras, CCD image sensors, and/or CMOS image sensors, etc.

The controller 66 may be a microprocessor-based processor. The controller 66 may include a processor, memory, etc. The memory of the controller 66 may store instructions executable by the processor. The sensor 70 is in communication with the controller 66 to communicate data to the controller 66. Based on the data communicated by the sensor 70, the controller 66 instructs the inflator 38 to activate.

The impact sensing system 68 may transmit signals through a communication network 72 (such as a controller area network (CAN) bus), Ethernet, and/or by any other wired or wireless communication network. The controller 66 may use information from the communication network 72 to control the activation of the inflator 38.

In normal operation, inflatable webbing 26, 126, 226 is in the uninflated position. In the event of a vehicle impact, the sensor 70 may detect the impact and transmit a signal through the communication network 72 to the controller 66. The controller 66 may transmit a signal through the communication network 72 to the inflator 38. Upon receiving the signal, the inflator 38 may discharge and inflate the inflatable webbing 26, 126, 226. The first lateral threads 30 stretch as the inflatable webbing 26, 126, 226 inflates, permitting expansion of the inflation chamber 40, at least at the first portion 49a and the second portion 49b. The longitudinal threads 28 help maintain the length of the inflatable webbing 26, 126, 226 to control kinematics of the occupant 32. In the inflated position the inflatable webbing 26, 126, 226 distributes forces generated in controlling kinematics of the occupant 32 during the vehicle impact, e.g., applying less force at the middle portion 51, 151, 251 than at the first portion 49a and the second portion 49b.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A seatbelt assembly, comprising:
a retractor; and
an inflatable webbing supported by the retractor and elongated along an axis, the inflatable webbing having longitudinal threads extending along the axis and lateral threads interwoven with the longitudinal threads, the lateral threads extending transverse to the axis and being more stretchable than the longitudinal threads.

2. The seatbelt assembly as set forth in claim 1, wherein the inflatable webbing in an inflated position has a necked portion.

3. The seatbelt assembly of claim 1, wherein the inflatable webbing in an inflated position includes a middle portion and opposing portions on opposite sides of the middle portion, the middle portion being smaller in cross-section perpendicular to the axis than the opposing portions.

4. The seatbelt assembly of claim 3, wherein the lateral threads are at the opposing portions, and the inflatable webbing includes second lateral threads interwoven with the longitudinal threads at the middle portion, the second lateral threads extending transverse to the axis and being less stretchable than the lateral threads.

5. The seatbelt assembly of claim 3, wherein the longitudinal threads and the lateral threads form a first panel and a second panel defining an inflation chamber.

6. The seatbelt assembly of claim 5, wherein the inflatable webbing includes a first edge and a second edge opposite the first edge, and the first panel is fixed to the second panel at the middle portion between the first edge and the second edge and along the axis.

7. The seatbelt assembly of claim 6, wherein the inflation chamber at the middle portion is spaced from the first edge and the second edge.

8. The seatbelt assembly of claim 6, wherein the inflation chamber at the middle portion abuts at least one of the first edge and the second edge.

9. The seatbelt assembly of claim 5, wherein the first panel is releasably fixed to the second panel prior to inflation and released from the second panel in the inflated position.

10. The seatbelt assembly of claim 3, further comprising a latch plate and a D-ring, wherein the opposing portions and the middle portion are between the latch plate and the D-ring.

11. The seatbelt assembly of claim 1, wherein the inflatable webbing includes an inside surface and an impermeable coating along the inside surface.

12. The seatbelt assembly of claim 1, wherein the longitudinal threads are nylon, and the lateral threads are spandex.

13. A seatbelt assembly comprising:
a retractor; and
an inflatable webbing elongated along an axis and supported by the retractor and inflatable to an inflated position, the inflatable webbing including a middle portion and opposing portions on opposite sides of the middle portion, the middle portion being smaller in cross-section perpendicular to the axis than the opposing portions when the inflatable webbing is in the inflated position.

14. The seatbelt assembly of claim 13, wherein the inflatable webbing includes longitudinal threads extending along the axis and lateral threads interwoven with the longitudinal threads at the opposing portions, the lateral threads extending transverse to the axis and being more stretchable than the longitudinal threads.

15. The seatbelt assembly of claim 14, wherein the inflatable webbing includes second lateral threads interwoven with the longitudinal threads at the middle portion, the second lateral threads extending transverse to the axis and being less stretchable than the lateral threads.

16. The seatbelt assembly of claim 13, wherein the inflatable webbing includes a first panel and a second panel each extending between a first edge and a second edge opposite the first edge, the first panel is fixed to the second panel at the middle portion between the first edge and the second edge and along the axis.

17. The seatbelt assembly of claim 16, wherein the inflatable webbing includes an inflation chamber between the first panel and the second panel at the middle portion and spaced from the first edge and the second edge.

18. The seatbelt assembly of claim 16, wherein the inflatable webbing includes an inflation chamber between the first panel and the second panel at the middle portion and abutting at least one of the first edge and the second edge.

19. The seatbelt assembly of claim 13, wherein the inflatable webbing includes an inside surface and an impermeable coating along the inside surface.

20. The seatbelt assembly of claim 13, wherein the inflatable webbing includes a first panel and a second panel, the first panel releasably fixed to the second panel prior to inflation of the inflatable webbing and released from the second panel in the inflated position.
